(19) United States
(12) Patent Application Publication
(10) Pub. No.: US 2026/0079273 A1
(43) Pub. Date: Mar. 19, 2026

(54) HIGHER-ORDER PARALLEL FAST SWEEPING METHOD IN ANISOTROPIC MEDIUM

(71) Applicants: Yi He, Beijing (CN); Young Seo Kim, Dhahran (SA)

(72) Inventors: Yi He, Beijing (CN); Young Seo Kim, Dhahran (SA)

(73) Assignee: SAUDI ARABIAN OIL COMPANY, DHAHRAN (SA)

(21) Appl. No.: 18/833,665

(22) PCT Filed: Jun. 12, 2024
(86) PCT No.: PCT/CN2024/098720

§ 371 Date: Jul. 26, 2024

(51) Int. Cl. G01V 1/30; G01V 1/28; G01V 20/00

(52) U.S. Cl. CPC G01V 1/305; G01V 1/282; G01V 20/00; G01V 2210/6222

(57) ABSTRACT

Methods and systems are disclosed. The method may include obtaining an anisotropic velocity model for a subterranean region of interest, where the anisotropic velocity model represents a propagation velocity of seismic waves discretized on a first grid of nodes representing the subterranean region of interest and initiating an initial anisotropic traveltime for each node of a second grid representing the subterranean region of interest, where the anisotropic traveltime comprises a seismic traveltime from a source location. The method may further include forming a computational system, comprising a discretization of a traveltime equation for the anisotropic velocity model, and determining an updated anisotropic traveltime for each node on the second grid based, at least in part, on a parallel fast sweeping Cuthill-McKee ordering solution to the computational system and the initial anisotropic traveltime for each node.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. Such a time-series is often termed a “trace”. The collection of traces recorded at many receiver locations generated by a seismic source at many source locations constitutes a seismic dataset.

To determine the earth structure, including the presence of hydrocarbons, the seismic dataset typically requires processing. Processing a seismic dataset includes a sequence of steps designed to correct for a number of issues, such as near-surface effects, noise, and irregularities in the seismic survey geometry, etc. In other steps a seismic velocity model may be determined from the seismic dataset representing the speed at which seismic waves propagate at various points within subsurface. The seismic dataset and the seismic velocity model may be combined using a process called “migration” to form a seismic image of the subsurface. Typically, such a seismic image displays points of high and low seismic reflection amplitude on a color scale or grayscale on a dense two-dimensional (2D) or three-dimensional (3D) grid of points representing the subsurface below the seismic survey area. Such a seismic image may then be interpreted, together with other information, to determine geological structures that may contain hydrocarbons extractable with a wellbore drilled from the surface.

Many steps in seismic processing, including velocity analysis and image formation (“migration”) require the combination of seismic samples generated by seismic sources located at a plurality of spatial positions on the surface and recorded by seismic receivers located at a plurality of spatial positions. The correct combination of these samples requires the determination and use of traveltimes that determine the time taken for a seismic wave to propagate from one spatial location to another, such as from a source location to a position in the subsurface or from a subsurface position to a receiver location.

The traveltime taken by a seismic wave to travel from one location to another depends on the seismic wave propagation velocity in the portion of the subsurface between the locations. Typically, this seismic velocity varies as a function of spatial position and may be termed “heterogeneous” or “inhomogeneous”. However, in addition, the seismic wave velocity may also vary as a function of propagation direction of the seismic wave. For example, a seismic wave propagating vertically at a given position may propagate at a different velocity than a seismic wave propagating horizontally at the same position. Such a directionally dependent seismic velocity is typically described as “anisotropic” or exhibiting “anisotropy”. In general, the seismic velocity in the subsurface may be both heterogeneous and anisotropic simultaneously.

In a typical seismic processing sequence the traveltime from hundreds of thousands of source locations and tens of millions of receiver locations to tens of millions of subsurface locations may be required. Calculating these traveltimes for heterogeneous and anisotropic subsurface regions in an accurate and efficient manner remains a pressing problem in seismic prospecting for hydrocarbon reservoirs.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to q method. The method may include obtaining an anisotropic velocity model for a subterranean region of interest, where the anisotropic velocity model represents a propagation velocity of seismic waves discretized on a first grid of nodes representing the subterranean region of interest and initiating an initial anisotropic traveltime for each node of a second grid representing the subterranean region of interest, where the anisotropic traveltime comprises a seismic traveltime from a source location. The method may further include forming a computational system, comprising a discretization of a traveltime equation for the anisotropic velocity model, and determining an updated anisotropic traveltime for each node on the second grid based, at least in part, on a parallel fast sweeping Cuthill-McKee ordering solution to the computational system and the initial anisotropic traveltime for each node.

In general, in one aspect, embodiments relate to a non-transitory computer-readable medium storing instructions executable by a computer processor, that when executed by the computer processor perform steps including, receiving an anisotropic velocity model for a subterranean region of interest, where the anisotropic velocity model represents a propagation velocity of seismic waves discretized on a first grid of nodes representing the subterranean region of interest, initiating an initial anisotropic traveltime for each node of a second grid representing the subterranean region of interest, where the anisotropic traveltime comprises a seismic traveltime from a source location, and forming a computational system, comprising a discretization of a traveltime equation for the anisotropic velocity model. The steps further include determining an updated anisotropic traveltime for each node on the second grid based, at least in part, on a parallel fast sweeping Cuthill-McKee ordering solution to the computational system and the initial anisotropic traveltime for each node, receiving a seismic dataset pertaining to the subterranean region of interest, and forming a seismic image of the subterranean region of interest based, at least in part on migrating the seismic dataset using the updated anisotropic traveltime for at least a portion of the nodes on the second grid.

In general, in one aspect, embodiments relate to a system including a seismic processing system and a seismic interpretation workstation. The seismic processing system may be configured to receive an anisotropic velocity model for a subterranean region of interest, where the anisotropic velocity model represents a propagation velocity of seismic waves discretized on a first grid of nodes representing the subterranean region of interest, initiate an initial anisotropic traveltime for each node of a second grid representing the subterranean region of interest, where the anisotropic traveltime comprises a seismic traveltime from a source location, and form a computational system comprising a higher-order weighted essentially non-oscillatory (WENO) approximation to a Godunov upwind-difference scheme discretization of an Eikonal equation for the anisotropic velocity model. The seismic processing system may be further configured to determine an updated anisotropic traveltime for each node on the second grid based, at least in pan, on a parallel fast sweeping Cuthill-McKee ordering solution to the computational system and the initial anisotropic traveltime for each node, receive a seismic dataset pertaining to the subterranean region of interest, and form a seismic image of the subterranean region of interest based, at least in part on migrating the seismic dataset using the updated anisotropic traveltime for at least at portion of the nodes on the second grid. The seismic interpretation workstation may be configured to identify a drilling target based, at least in part, on the seismic image.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIG. 1 shows a flowchart in accordance with one or more embodiments:

FIG. 2A depicts a seismic acquisition system in accordance with one or more embodiments;

FIG. 2B show a portion of a seismic dataset in accordance with one or more embodiments;

FIG. 3A illustrates a grid of nodes discretizing a subterranean region of interest in accordance with one or more embodiments;

FIG. 3B shows a seismic velocity model pertaining to the subterranean region of interest in accordance with one or more embodiments;

FIG. 4A shows isotropic slownesses in accordance with one or more embodiments:

FIG. 4B shows anisotropic slownesses in accordance with one or more embodiments,

FIG. 5 depicts a snapshot of a seismic wavefield in accordance with one or more embodiments;

FIG. 6 depicts a seismic image in accordance with one or more embodiments:

FIG. 7 shows a flowchart in accordance with one or more embodiments:

FIG. 8 depicts a drilling system in accordance with one or more embodiments; and

FIG. 9 depicts a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal umbers is to distinguish between the elements. By way of an example, a first element is distinct from a second element, and the first element may encompass more than one element and succeed (or precede) the second element in an ordering of elements.

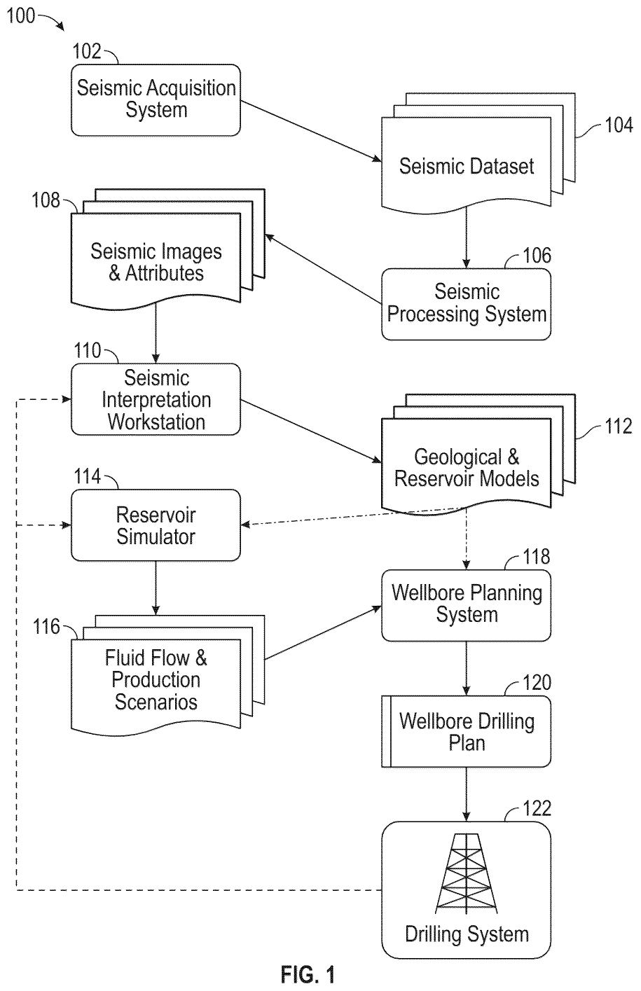

In the following description of FIGS. 1-9, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a traveltime” includes reference to one or more of such traveltimes.

Terms such as “approximately” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Seismic traveltimes are used in many applications of seismic data processing, such as velocity analysis, tomography, and seismic image formation (“migration”), to permit the combination of samples collected at different spatial locations. Frequently these established processes require the estimation of traveltimes for seismic velocity models that digitally represent the characteristics of seismic wave propagation within portions of the subsurface. For example, seismic data processing methods may require the determination of seismic traveltimes at each node of a regular or irregular grid representing the subsurface. Methods and systems are provided herein for accurately and efficiently determining seismic traveltimes on a grid of points representing the subsurface, in particular, for subsurface regions exhibiting anisotropic seismic propagation velocities.

FIG. 1 depicts a flowchart (100) in accordance with one or more embodiments FIG. 1 illustrates conventional steps of acquiring remote sensing data, processing the remote sensing data, forming a geological model, optionally simulating the flow of fluids, including hydrocarbons, though the geological model, planning of wellbores including their surface position, trajectories, targets and completions (such as casing and/or hydraulic fracturing), and the drilling of those wellbores. Although the steps in flowchart (100) are shown in sequential order, it will be apparent to one of ordinary skill in the art, that some steps may be conducted in parallel, in a different order than shown, or may be omitted without departing form the scope of the invention disclosed herein.

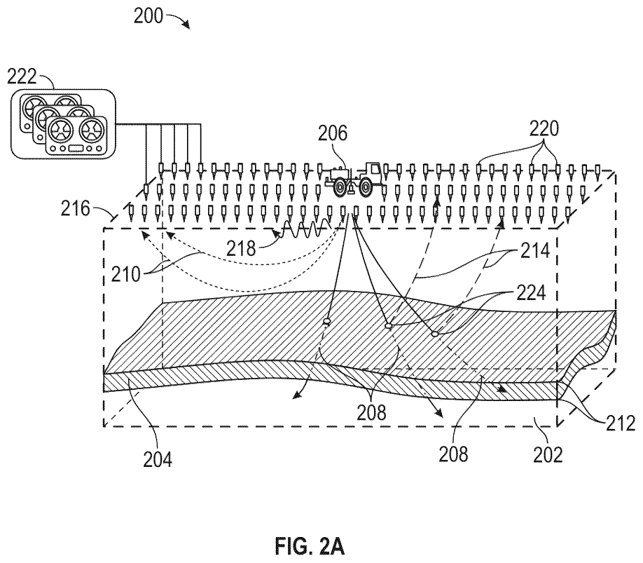

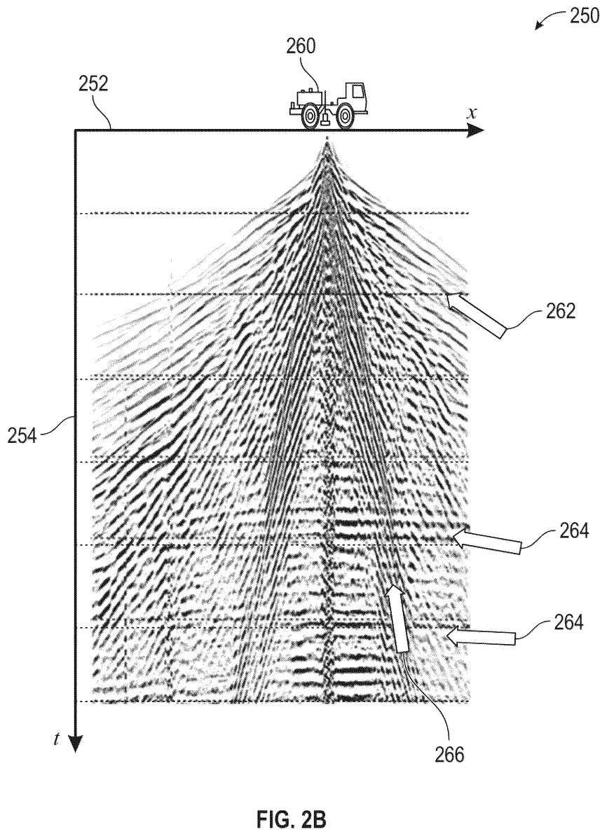

For example, flowchart (100) may begin with the use of a seismic acquisition system (102) to acquire a seismic dataset (104) over a subterranean region of interest. The seismic acquisition system (102) will be described in more detail in the context of FIG. 2A, and an example of a portion of a seismic dataset is shown in FIG. 2B. Other remote sensing datasets may also be collected at this stage to characterize the subterranean region of interest. For example, resistivity, transient electromagnetic using either active or passive sources, and/or gravitation surveys may be collected.

The seismic dataset contains seismic recordings that are influenced by the geological structure of the subterranean region. However, seismic datasets (104) also contain a wide variety of noise and distortion and does not in its unprocessed “raw” form display significant useful information about the subterranean region. Consequently, seismic datasets (104) are typically processed to remove or attenuate noise and to correctly locate geological boundaries that reflect seismic waves (“seismic reflectors”) in two-dimensional (“2D”) or three-dimensional (“3D”) space within the subterranean region.

To determine earth structure, including the presence of hydrocarbons, the seismic data set must be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest, and to use in determining a drilling target. Each of these steps may be accompanied by one or more quality control steps. Critical steps in processing seismic data may include velocity analysis and tomography, beam forming and seismic migration. Seismic migration is a process by which seismic events are re-located in either space or time to their true subsurface positions. Many of these critical steps may require the calculation of traveltimes on a grid of points representing the subterranean region.

It will be appreciated by one of ordinary skill in the art that seismic datasets (104) are extremely large, typically occupying hundreds of Terabytes or more than a Petabyte in size. (corresponding to between 10 trillion (10¹³) and 100 trillion (10¹⁴) data samples) and cannot be manipulated or “processed” without the assistance of a purpose configured seismic processing system (106). Similarly, grids representing the subterranean region may routinely include millions or tens of millions of nodes and as a result purpose configured seismic processing system (106) may be required to determine traveltimes on the nodes.

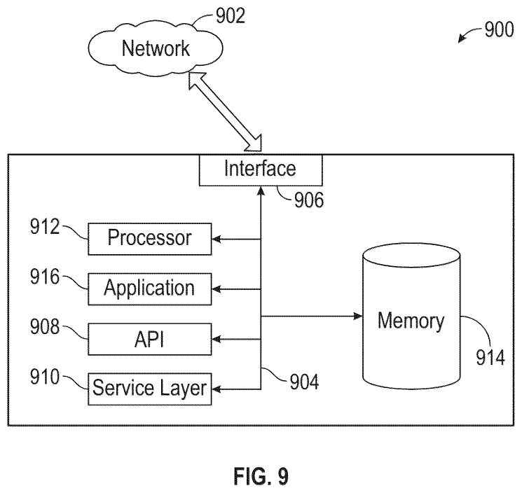

A seismic processing system (106) may be composed of a computer system, such as the computer system shown in FIG. 9. However, a seismic processing system will typically be configured with appropriate seismic processing software and augmented with a number of purpose specific elements, such as high capacity tape drives or hard drives connected through high-speed buses to computer processing units (“CPUs”). Further the CPUs of a seismic processing system will typically be connected to a plurality of graphical processing units (“GPUs”) that perform many of the computationally intensive operations on the seismic dataset (104), banks of high-speed tape, or hard-drive, readers to read the data from storage, high-speed tape or hard-drive writers to output final or intermediate results, and high-speed communication buses to connect these elements.

The result of processing a seismic dataset (104) with a seismic processing system (106) may be a seismic image (108). The seismic image may be two-dimensional (“2D”) or three-dimensional (“3D”) image of the points within the subsurface that generate a distinctive seismic response. For example, the seismic image (108) may display the points at which seismic energy is reflected, or scattered, within the subsurface. Other seismic characteristic or “attributes” of the subsurface may be displayed as a seismic image (108). For example, the strength of conversion of energy from one type of seismic wave to another, or the strength of absorption of seismic energy, or the velocity of seismic propagation may be displayed as a function of subsurface position in the seismic image (108). The examples of seismic attributes given above are purely illustrative, and a person of ordinary skill in the art will appreciate that anyone of dozens of other attributes may be displayed as a seismic image (108) and the examples described should not be interpreted as limiting the scope of the invention in any way.

The seismic image (108) is an image, typically composed of pixels of varying intensity, and is not itself a model of the geological structure of the subterranean region to which it pertains. To determine the geological structure corresponding to, or that produced, the seismic image (108) the seismic image (108) is typically “interpreted” using a seismic interpretation workstation (110). In addition to identifying features within the seismic image, interpretation may include the integration or synthesis of information from other sources, in particular from well logs.

A seismic interpretation system (110) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs. Additional data may be used within the seismic interpretation workstation (110) to facilitate the interpretation of the seismic dataset. Such additional data may include well logs acquired from previously drilled wells and acquired either while-drilling or via wireline conveyed well logging tools after drilling. Such data may also include non-seismic remote sensing datasets such as resistivity, transient electromagnetic, and/or gravitational surveys.

Interpreters may pick and interpret key geological horizons within seismic data to identify stratigraphic layers, boundaries, and structural features. Horizon interpretation tools and workflows allow for the accurate extraction of geological information from seismic volumes. For example, a seismic interpretation system (110) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation system (110) to build 3D geological models by integrating seismic data with well-log data, geological knowledge, and other geophysical information. These models help in estimating reservoir properties, optimizing well locations, and predicting hydrocarbon distribution Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (110) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

The seismic interpretation system (110) are essential tools for geoscientists involved in exploration and production activities, helping them make informed decisions about drilling, locations, optimize production strategies, and understand complex subsurface geological structures. The seismic interpretation system (110) may be a specialized computer system used by geoscientists and seismic interpreters for analyzing and interpreting seismic data.

Seismic interpretation involves intensive tasks like data visualization, horizon picking, attribute analysis, and 3D modeling. A high-performance seismic interpretation system (110) with a powerful processor, ample memory, and a high-resolution display is essential to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (110) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system such as solid-state drives (SSDs) or RAID arrays, is necessary to store and access this data efficiently. The seismic interpretation system (110) often requires network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. A seismic interpretation workstation (110) may be augmented with purpose specific peripherals such as high capability display devices that may include immersive or virtual reality devices, such as virtual-reality headsets or immersive “caves”. Additionally, color-calibrated and high-accuracy input devices enhance the precision of interpretation tasks like picking horizons or drawing geological features. The seismic interpretation system (110) should have backup solutions in place to protect valuable data from loss or damage. Automated backup systems, external storage devices, or network-attached storage (NAS) can be utilized to ensure data safety. In some cases, seismic interpreters may need remote access to the seismic interpretation system (110) or collaborate with colleagues remotely. Setting up remote access capabilities, such as Virtual Private Networks (VPNs) or remote desktop solutions, allows interpreters to work from different locations and share their work effectively. The seismic interpretation system (110) may be customized to meet the needs of interpreters and the specific requirements of projects. The hardware specifications may vary based on factors like the complexity of interpretations, the size of datasets, and the software tools utilized.

The result of interpreting the seismic image may be a geological model (112) of the subsurface, including reservoir models of hydrocarbon reservoirs within the subterranean region of interest. Geological models (112) may include the locations of geological interfaces, such as the boundary between volumes (“formations”) containing different rock types (“facies”), and faults and fractures. Geological models may also include descriptions of the characteristics of the different facies including characteristics such as porosity and permeability, and the relative amounts of different fluids, such as gas, oil and brine, within the pores in each facies.

In some embodiments, the geological models (112) may be used directly to create a wellbore drilling plan (120) using a wellbore planning system (118). Such a wellbore drilling plan (120) may contain drilling targets, often geological regions expected to contain hydrocarbons. The wellbore planning system (118) may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system. Similarly, the wellbore drilling plan (120) may include a determination of wellbore caliper, and casing points.

The wellbore planning system (118) may include dedicated software stored on a memory of a computer system, such as the computer system shown in FIG. 12. The wellbore plan (120) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

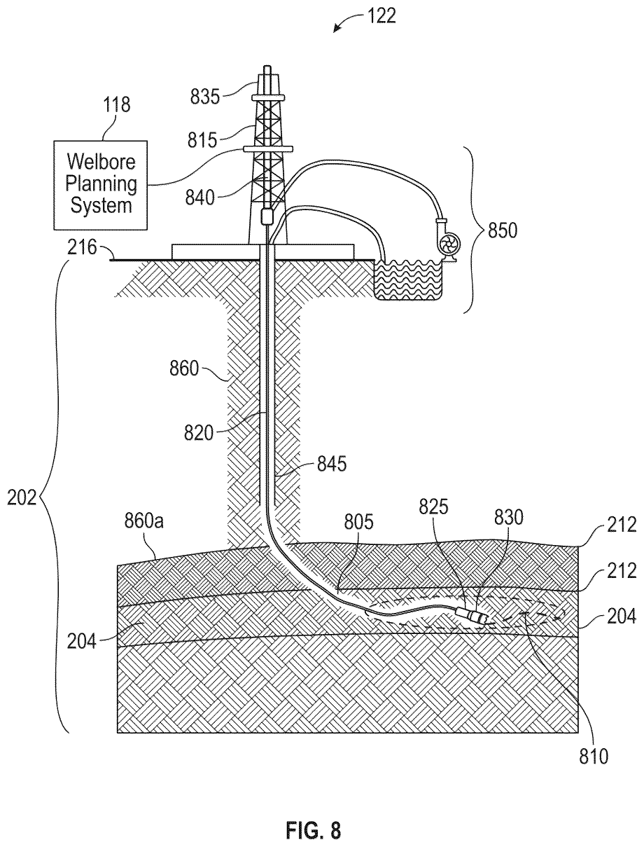

The wellbore path, such as the wellbore path (1004) shown in FIG. 8, may include a starting surface location of the wellbore, or a subsurface location within an existing wellbore, from which the wellbore (1002) may be drilled. The wellbore path (1004) may further include a terminal location that may intersect with the previously located hydrocarbon reservoir, such as hydrocarbon reservoir (204) shown in FIG. 2. The wellbore path (1004) may further still include wellbore geometry information such as wellbore diameter and inclination angle and when each of these change along the depth of the wellbore. If casing is used, the wellbore plan (120) may include casing type or casing depths. Furthermore, the wellbore plan 120) may consider other engineering constraints such as the maximum wellbore curvature (“dog-log”) that a drillstring of a drilling system may tolerate and the maximum torque and drag values that the drilling system may provide. The wellbore plan (120) may further define associated drilling parameters, such as the planned depths at which drilling may be paused and casing will be inserted to support the wellbore (1002) to prevent formation fluids entering the wellbore (1002) and the drilling mud weights (densities) and types that may be used during drilling of the wellbore (1002).

In some embodiments, the geological model (112) may be input to a reservoir simulator (114). A reservoir simulator (114) includes functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator (114) may be used to predict changes in fluid flow, including fluid flow into wells penetrating the reservoir as a result of planned well drilling, and/or fluid injection and extraction. For example, the reservoir simulator may be used to predict flid-flow and production scenarios (116) including changes in hydrocarbon production rate that would result from the injection of water into the reservoir from wells around the reservoirs periphery.

The reservoir simulator (114) may use a geological model or reservoir model (112) that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defied at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected from well logs acquired in well penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators solve a set of mathematical governing equations that represent the physical laws that govern fluid flow in porous, permeable media. For example, the flow of a single-phase slightly compressible oil with a constant viscosity and compressibility the equations capture Darcy's law, the continuity condition and the equation of state.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

The fluid flow and production scenarios (116) predicted by the reservoir simulator (114) may then be used by the wellbore planning system (118) to determine the wellbore drilling plan (120).

While a wellbore drilling plan (120) is formed using the best available information at the time at which it is formed, additional information may become available when drilling the wellbore specified by the plan. For example, well logs providing new information about the reservoir structure and characteristic may be acquired while drilling (so-called “logging-while-drilling” (LWD) logs or during drilling pauses in, or at the completion of drilling of, a wellbore specified by the drilling plan (120). These well logs acquired during pauses or at the cessation of drilling may be acquired using wireline or coiled tubing conveyed logging tools. However acquired, these new wells may be used to update geological and reservoir models (112) with the aid of a seismic interpretation workstation or to directly update the reservoir simulation performed by the reservoir simulator (114).

FIG. 2A shows a seismic acquisition system (200) configured to acquiring a seismic dataset pertaining to a subterranean region of interest (202). The subterranean region of interest (202) may or may not contain a hydrocarbon reservoir (204). The purpose of the seismic survey may be to determine whether or not a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (206), when activated, generates radiated seismic waves, such as those with paths indicated by the rays (208). The radiated seismic waves may be bent (“refracted”) by variations in the speed of seismic wave propagation within the subterranean region (202) and return to the surface of the earth (216) as refracted seismic waves (210), or “diving waves”. Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs.

At the surface, the refracted seismic waves (210) and reflected seismic waves (214) may be detected by seismic receivers (220). On land a seismic receiver (220) may be a geophone (that records the velocity of ground motion) or an accelerometer (dhal records the acceleration of ground notion). A geophone may record on component, such as the vertical component, of the velocity of ground motion or two or three components. Alternatively, geophones may be arranged in groups of two or three, each of which record a single component of the velocity of ground motion and arranged such as each component is orthogonal to the components recorded by the other geophones in the group. Similarly, an accelerometer may record one, two, or three components of the acceleration of ground motion, or be arranged in groups each member of the group measuring a single component orthogonal to that measured by other accelerometers in the group. In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receiver (220) may be positioned at a seismic receiver location that may be denoted (xᵣ, yᵣ, zᵣ) where x and y represent orthogonal axes, such as North-South and East-West, on the surface of the earth (216) above the subterranean region of interest (202) and zᵣ, indicates elevation. Note, the elevation, zᵣ, may often be neglected. Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). In some case, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey. Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other cases, such as marine seismic acquisition (not shown) the seismic source may be towed a short distance behind a seismic vessel and strings of receiver, attached to multiple cables (“streamers”) are towed behind the seismic sources. Thus, a seismic dataset, the aggregate of all the seismic data acquired by the seismic survey, may be represented as a five-dimensional volume (four space dimensions and one time dimension) with coordinate axes (xᵣ, yᵣ, yₛ, yₛ, t).

Displaying, processing, and interpreting a five dimensional volume may be challenging. Consequently, only a portion of seismic datasets are typically displayed for visual inspection. For example, FIG. 2B shows a common shot gather (250), corresponding to a single shot point (260) and seismic receivers distributed on either side of the shot point (260) along a seismic source—seismic receiver offset direction indicated on the horizontal axis (252). The recording time, that is the time after the activation of the seismic source is indicated on the vertical axis (254). Various different types of seismic waves are indicated, including refracted waves (262), refracted by shallow refractors, seismic reflected waves, such as reflections (264), and ground-roll or surface waves (266). These different types of waves may be distinguished from one another by the variation of their traveltimes with seismic source seismic receiver offset.

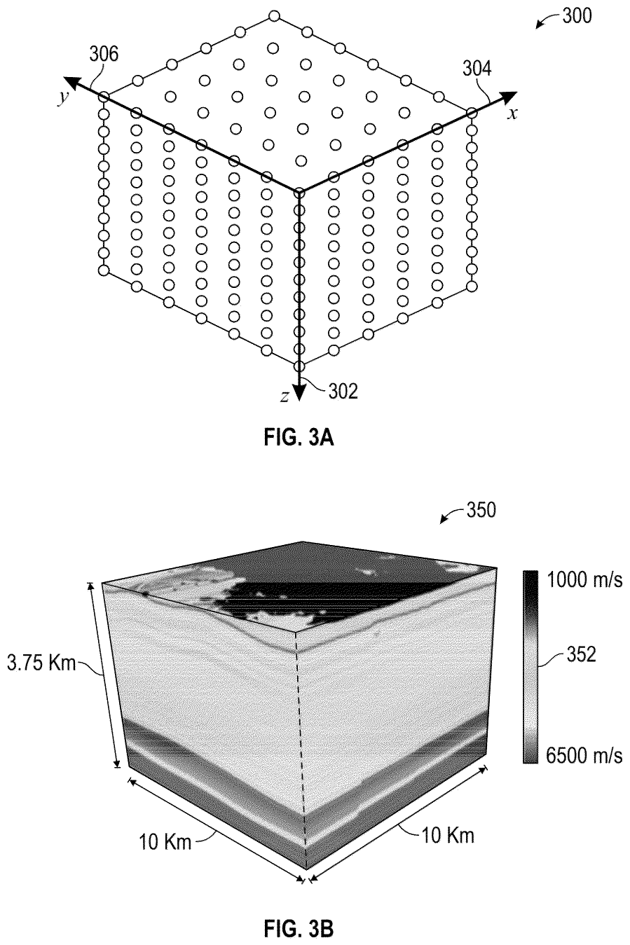

FIG. 3A depicts the nodes of a grid representing a subterranean region. In some embodiments the grid may be a regular uniform grid, such as grid (300), while in other embodiments the grid may be irregular and or non-uniform. For example, while grid (300) uses orthogonal axes, with one axis (302) coinciding with the vertical direction and the other two axes (304) and (306) arranged orthogonally to one another and to the vertical axis (302), the nodes may be arranged with different increments along one or more of the axes. For example, the nodes may be more closely spaced along the vertical axis (302). In other embodiments, the grids may use non-Cartesian axes, such as cylindrical or spherical axes, and/or may use irregular increments of distance between points.

At each of the nodes in the grid (300) a seismic velocity may be specified or determined. The resulting grid of nodes may form a seismic velocity model (350) forming a 3D representation of the variation of the seismic velocity in the subsurface. The seismic velocity at each node may be displayed using a grayscale (352).

Similarly, a seismic traveltime may be calculated for each node in a grid for seismic waves emanating from a seismic source located on the surface of the earth or at a non-zero depth below it. In some embodiments the seismic traveltimes may be calculated at the same nodes used to define the velocity mode, while in other embodiments different grids of nodes may be used for the seismic velocity model and for the seismic traveltimes. In the latter case, the seismic velocity model may be defied on a first grid and the seismic traveltimes determined on a second grid. While the first grid and the second grid may represent the same portion of the subterranean region the second grid may use finer or coarser sampling than the first grid. In other embodiments the first grid may be irregular and the second grid regular or vice versa. However, in many embodiments the nodes of the first grid and the nodes of the second grid may represent the same subterranean spatial locations, i.e., for each node on the first grid n₁(x₁, y₁, z₁) there is a corresponding node on the second grid n₂(x₁, y₁, z₁), where (x₁, y₁, z₁) notes the same spatial location in the subsurface.

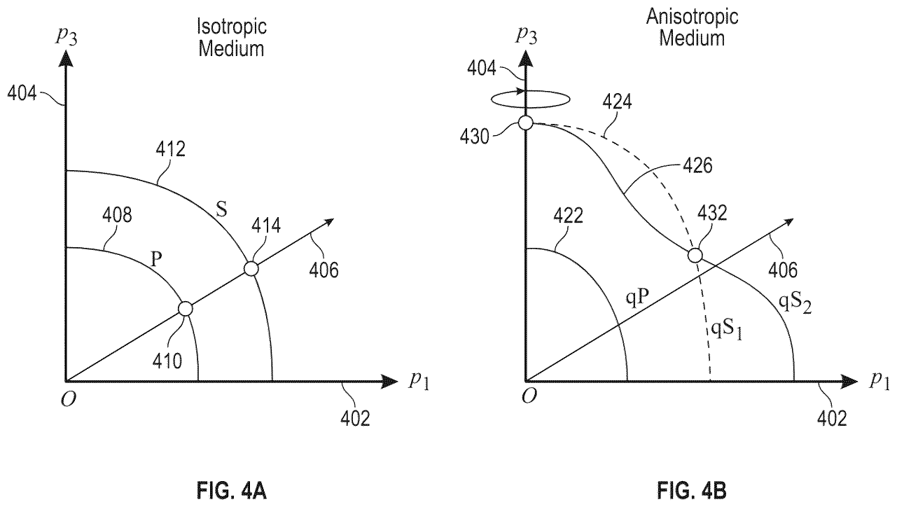

The velocities displayed in the velocity model (350) may display isotropic velocities. i.e., while they may vary with position, they are invariant with direction of propagation. An example of such isotropic velocities is shown in FIG. 4A. However, seismic velocities may also vary with direction of propagation, such as the seismic velocities shown in FIG. 4B.

Turning to FIG. 4A, FIG. 4A depicts the slownesses (the reciprocal of velocity) for an isotropic velocity model. An isotropic velocity model may support a pressure wave (labelled “P”) and two shear waves with orthogonal polarizations but the same propagation velocity (labelled “S”). In FIG. 4A the components of slowness are shown on the two axes. Thus, a horizontally propagating wave has a P- or S-slowness that plot on the horizontal axis (402) and a vertically propagating wave has a P- or S-slowness that plot on the vertical axis (404). P-waves traveling at an oblique angle to the vertical and horizontal axes, such as in the direction indicated by the arrow (406), have a slowness that plot at other points on the curve (408), such as the point (410). Similarly. S-waves traveling at the oblique angle indicated by the arrow (406), have a slowness that plots at other points on the curve (412), such as the point (414). In isotropic media the curves (408) and (412) form arcs of circles.

Turning to FIG. 4B. FIG. 41B depicts the slownesses fir an anisotropic velocity model. For any given propagation direction, such as the direction indicated by the arrow (406) an anisotropic material supports three waves. Rather than P- and S-waves, these three waves are typically referred to a quasi-P (“qP”) and a first quasi-S (“qS₁”) and second quasi-S (“qS₂”), waves, for reasons that lie beyond the scope of this disclosure. In contrast to isotropic media, in anisotropic media the slowness curve for qP waves (422), qS₁ (424), and qS₂ (426) are not arcs of a circle. Furthermore, the slowness curves for qS₁ (424), and qS₂ (426) indicate the qS₁ and qS₂ are not equal, except at a finite number of intersections (“singularities”), such as points (430) and (432). It will be noted by one of ordinary skill in the art, that FIG. 4B indicates only one non-limiting example of slowness curves for anisotropic media and the precise shapes of the slowness curves may vary from one anisotropic material to another. In particular, the slowness curves of FIG. 4B may be regarded as rotationally symmetric around the vertical axis (404) and to be symmetric under the operation of reflection in a plane normal to the vertical axis (404) and containing the axis (402). Such a material may be denoted as “transversely anisotropic with a vertical axis of symmetry (TIV)”. More generally, a similar material where the axis of rotational symmetry does not align with the vertical direction may be termed “transversely isotropic” (TI). While TI and TIV materials as frequently useful in describing anisotropy encountered in the subsurface, the scope of at least some of the embodiments are not limited to these materials.

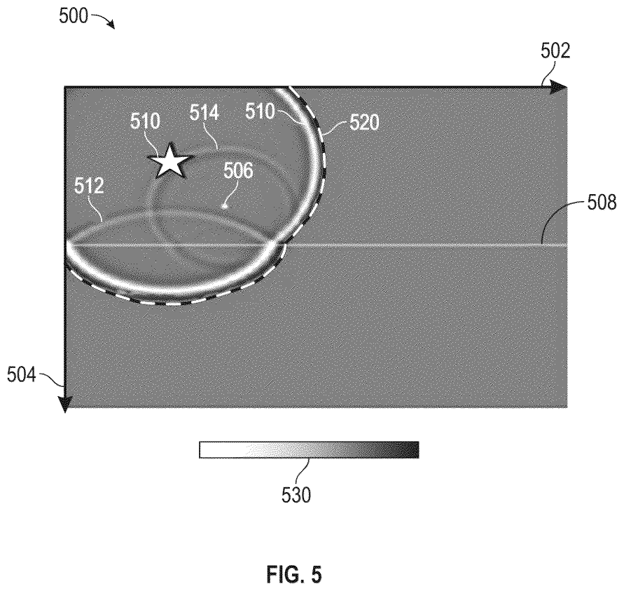

FIG. 5 depicts a 2D snapshot of a wavefield (500) in accordance with one or more embodiments. The snapshot represents a parameter of the wavefield, such as a component of the displacement or a pressure, displayed as a function of location on a grid, such as the second grid, spanned by the orthogonal axes (502) and (504). For example, axis (502) may indicate a horizontal location and axis (504) may indicate a vertical location. The wavefield snapshot also indicates the location of a point scatterer of seismic waves (506) and a horizontal interface (508) that reflects seismic waves. For example, horizontal reflector (508) may represent the boundary between a portion of the subsurface with a slower velocity of seismic wave propagation and a portion with a higher velocity of seismic wave propagation.

The snapshot of the wavefield (500) indicates the value of the parameter on a grayscale (530), for example with large positive values indicated by black, zero values indicated by mid-gray tones, and large negative values indicated by white. The snapshot (500) shows the radiated or “direct” wavefront (510), the reflected wavefront (512) reflected by the horizontal reflector (508), and the scattered wavefield (514) scattered by the point scatterer (506). In addition, snapshot (500) shows an isochron of the traveltime of the direct traveltime as a dashed white line (520). It may be noted that the isochron (520) coincides with the edge of the direct wavefield (510) furthest from the source (510). Typically, the computational cost of computing the entire wavefield, of which FIG. 5 shows a snapshot (500), is many tunes greater than computing the traveltimes, such as the traveltimes from which the isochron (520) is derived.

In accordance with one or more embodiments, the traveltime at each node in the second grid may be determined using an eikonal equation:

$$\vert ∇ T ( x ) \vert = S ( x ) , Ω ⊂ {R}^{3} \qquad Eqn ( 1 )$$

$$T ( x ) = 0 , x ∈ Γ ⊂ Ω \qquad Eqn ( 2 )$$

where S(x) is the slowness in the three-dimensional space Ω, and Γ represents a set of seismic source locations that drive the motion propagation through the fastest possible path. The operator ∇ denotes the spatial first derivative operator (often termed “gradient”) and the operator | | denotes the modulus.

In isotropic materials. S(x) is the function only of the spatial coordinates, while in anisotropic materials, particularly a transverse isotropic material, S(x) is a function of the spatial coordinates x, the anisotropy parameters, and the direction of wave propagation (“wave vector”) (106) relative to the symmetry axis (404). In some embodiments for transversely anisotropic materials, the anisotropic parameters may consist of five independent constants, c₁₁, c₁₃, c₃₃, c₄₄, and c₆₆. In other embodiment, particularly where the anisotropy is weak, the anisotropy parameters may be the Thomson parameters:

The qP wave velocity parallel to the symmetry axis.

$${Vp}_{0} = \sqrt{\frac{{c}_{33}}{ρ}} , \qquad Eqn ( 3 )$$

the qS wave velocity parallel to the symmetry axis:

$${V}_{{S}_{0}} = \sqrt{\frac{{c}_{44}}{ρ}} , \qquad Eqn ( 4 )$$

half the fractional change in the square of the qP wave velocity between the symmetry axis (404) and the normal to the symmetry axis (404):

$$ε = \frac{{c}_{11} - {c}_{33}}{2 {c}_{33}} \qquad Eqn ( 5 )$$

half the fractional change in the square of the qS wave velocity between the symmetry axis (404) and the normal to the symmetry axis (404):

$$γ = \frac{{c}_{66} - {c}_{44}}{2 {c}_{44}} \qquad Eqn ( 6 )$$

and an ellipticity parameter:

$$δ = \frac{{( {c}_{13} - {c}_{44} )}^{2} - {( {c}_{33} - {c}_{44} )}^{2}}{2 {c}_{33} ( {c}_{33} - {c}_{44} )} . \qquad Eqn ( 7 )$$

Therefore, a key point is the determination of S(x) for each node in the grid representing the anisotropic medium. Firstly, the wave vector may be determined as

$$( \frac{\partial T}{\partial x} , \frac{\partial T}{\partial y} , \frac{\partial T}{\partial z} )$$

using a recursive loop and each previously determined traveltime for each node on the grid. Secondly, the unit vector of the symmetry axis (404) of the media may be defined as (cos φ sin θ, sin φ sin θ, cos θ), where φ is the azimuth of the symmetry axis and θ is the dip angle of the symmetry axis. Thirdly, an angle α between the wave vector and the symmetry axis at each node may be expressed as:

$$α = {cos}^{- 1} [ ( \frac{\partial T}{\partial x} cos φ sin θ + \frac{\partial T}{\partial y} sin φ sin θ + \frac{\partial T}{\partial z} cos θ ) / {( {( \frac{\partial T}{\partial x} )}^{2} + {( \frac{\partial T}{\partial y} )}^{2} + {( \frac{\partial T}{\partial z} )}^{2} )}^{\frac{1}{2}} ] \qquad Eqn ( 8 )$$

For weak anisotropy, using parameters, see “Thomsen, L. Weak elastic anisotropy. Geophysics, vol. 51, No. 10, p1954-1966, 1986”, the slowness S(x) of P wave at each node may be written as:

$$S ( x ) = 1 / [ {v}_{p 0} ( x ) ( 1 + δ ( x ) {sin}^{2} α {cos}^{2} α + ε ( x ) {sin}^{4} α ) ] \qquad Eqn ( 9 )$$

Note, the anisotropy parameters, vₚ₀(x), δ(x), and ε(x), may each vary as a function of position.

Equation (1) may be discretized using a finite-difference approximation. To simplify the notation, one may write the location of each node in a cartesian grid as x=iΔx+jΔy+kΔz, where Δx, Δy, Δz are the grid step or increment along the x, y and z axes, respectively, and write S(x)=S_{i,j,k}. To further simplify notation, we will use the case where h=Δx=Δy=Δz by way of illustration.

A common first-order discretization of the Eikonal equation, equation (1), uses a Godunov upwind-difference scheme to approximate partial derivatives of T(x). A discretized version of Eqn (1) may then be expressed as:

$${max ( \frac{{T}_{i , j , k} - {T}_{i , j , k}^{x min}}{h} , 0 )}^{2} + {max ( \frac{{T}_{i , j , k} - {T}_{i , j , k}^{y min}}{h} , 0 )}^{2} + {max ( \frac{{T}_{i , j , k} - {T}_{i , j , k}^{x min}}{h} , 0 )}^{2} = {S}_{i , j , k}^{2} \qquad Eqn ( 10 )$$

$$where$$

$${T}_{i , j , k}^{xmin} = min ( {T}_{i - 1 , j , k} , {T}_{i + 1 , j , k} ) \qquad Eqn ( 11 )$$

$${T}_{i , j , k}^{ymin} = min ( {T}_{i , j - 1 , k} , {T}_{i , j + 1 , k} ) \qquad Eqn ( 12 )$$

$${T}_{i , j , k}^{xmin} = min ( {T}_{i , j , k - 1} , {T}_{i , j , k + 1} ) \qquad Eqn ( 12 )$$

as grid node index i=1, 2, . . . , I; j=1, 2, . . . , J; k=1, 2, . . . , K, respectively. Note that for each local grid (i, j, k), the slowness S_{i,j,k} is determined by Eqn. (9) in each iterative update step.

However, in accordance with one or more embodiments disclosed herein, greater accuracy of the solution may be achieved by approximating the derivatives Tₓ, T_{y} and T_{z} with a higher-order differencing operator. By way of illustration only, we describe the use of a third order Weighted Essentially Non-Oscillatory (WENO) approximation. The approximations for partial derivatives Tₓ at the grid node (i, j, k) are as:

$${( {T}_{x} )}_{i , j , k}^{-} = ( 1 - {w}_{-} ) ( \frac{{T}_{i + 1 , j , k} - {T}_{i - 1 , j , k}}{2 h} ) + {w}_{-} ( \frac{3 {T}_{i , j , k} - 4 {T}_{i - 1 , j , k} + {T}_{i - 2 , j , k}}{2 h} ) where {w}_{-} = \frac{1}{1 + 2 {r}_{-}^{{1}^{′}}} = {r}_{-} = \frac{ϵ + {( {T}_{i , j , k} - 2 {T}_{i - 1 , j , k} + {T}_{i - 2 , j , k} )}^{2}}{ϵ + ( {T}_{i + 2 , j , k} - 2 {T}_{i , j , k} + {T}_{i - 1 , j , k} )} \qquad Eqn ( 13 )$$

$${( {T}_{x} )}_{i , j , k}^{+} = ( 1 - {w}_{+} ) ( \frac{{T}_{i + 2 , j , k} - {T}_{i - 1 , j , k}}{2 h} ) + {w}_{+} ( \frac{- {T}_{i + 2 , j , k} + {T}_{i + 2 , j , k} - 3 {T}_{i , j , k}}{2 h} ) \qquad Eqn ( 14 )$$

where

$$w + \frac{1}{1 + 2 {r}_{+}^{{1}^{′}}} {r}_{+} = \frac{ϵ + {( {T}_{i + 2 , j , k} - 2 {T}_{i + 1 , j , k} + {T}_{i , j , k} )}^{2}}{ϵ + ( {T}_{i + 2 , j , k} - 2 {T}_{i , j , k} + {T}_{i - 1 , j , k} )}$$

and ϵ is small value to prevent division by zero. In the same way, we have the expressions of

$${( {T}_{y} )}_{i , j , k}^{-} , {( {T}_{y} )}_{i , j , k}^{+} , {( {T}_{z} )}_{i , j , k}^{-} , and {( {T}_{z} )}_{i , j , k}^{+} .$$

Note the following identities hold:

$${( {T}_{x} )}_{i , j , k}^{-} = \frac{{T}_{i , j , k} - [ {T}_{i , j , k} - h \cdot {( {T}_{x} )}_{i , j , k}^{-} ]}{h} , {( {T}_{x} )}_{i , j , k}^{+} = \frac{[ {T}_{i , j , k} + h \cdot {( {T}_{x} )}_{i , j , k}^{+} ] - {T}_{i , j , k}}{h} \qquad Eqn ( 15 )$$

$${( {T}_{y} )}_{i , j , k}^{-} = \frac{{T}_{i , j , k} - [ {T}_{i , j , k} - h \cdot {( {T}_{y} )}_{i , j , k}^{-} ]}{h} , {( {T}_{y} )}_{i , j , k}^{+} = \frac{[ {T}_{i , j , k} + h \cdot {( {T}_{y} )}_{i , j , k}^{+} ] - {T}_{i , j , k}}{h} \qquad Eqn ( 16 )$$

$${( {T}_{z} )}_{i , j , k}^{-} = \frac{{T}_{i , j , k} - [ {T}_{i , j , k} - h \cdot {( {T}_{z} )}_{i , j , k}^{-} ]}{h} , {( {T}_{z} )}_{i , j , k}^{+} = \frac{[ {T}_{i , j , k} + h \cdot {( {T}_{z} )}_{i , j , k}^{+} ] - {T}_{i , j , k}}{h} \qquad Eqn ( 17 )$$

Replacing T_{i-1,j,k}, T_{i+1,j,k}, T_{i,j-1,k}, T_{i,j+1,k}, T_{i,j,k-1}, T_{i,j,k+1} in Eqn (10) with the expressions in Eqns (15)-(17), we construct the third-order scheme:

$${max ( \frac{{T}_{i , j , k}^{new} - {T}_{i , j , k}^{xmin}}{h} , 0 )}^{2} + {max ( \frac{{T}_{i , j , k}^{new} - {T}_{i , j , k}^{ymin}}{h} , 0 )}^{2} + {max ( \frac{{T}_{i , j , k}^{new} - {T}_{i , j , k}^{zmin}}{h} , 0 )}^{2} = {S}_{i , j , k}^{2} \qquad Eqn ( 18 )$$

$${T}_{i , j , k}^{xmin} = min ( {T}_{i , j , k} - h \cdot {( {T}_{x} )}_{i , j , k}^{-} , {T}_{i , j , k} + h \cdot {( {T}_{x} )}_{i , j , k}^{+} ) \qquad Eqn ( 19 )$$

$${T}_{i , j , k}^{ymin} = min ( {T}_{i , j , k} - h \cdot {( {T}_{y} )}_{i , j , k}^{-} , {T}_{i , j , k} + h \cdot {( {T}_{y} )}_{i , j , k}^{+} ) \qquad Eqn ( 20 )$$

$${T}_{i , j , k}^{zmin} = min ( {T}_{i , j , k} - h \cdot {( {T}_{z} )}_{i , j , k}^{-} , {T}_{i , j , k} + h \cdot {( {T}_{z} )}_{i , j , k}^{+} ) \qquad Eqn ( 21 )$$

where

$${T}_{i , j , k}^{new}$$

in Eqn (18) denotes an-updated solution for the traveltime at the grid node (i, j, k) and T_{i,j,k} in Eqns (13)-(21) denotes a current value of traveltime. Since speed of the wave front is positive

$$( {S}_{i , j , k} > 0 ) , {T}_{i , j , k}^{new}$$

must be larger than

$${T}_{i , j , k}^{xmin} , {T}_{i , j , k}^{ymin} and {T}_{i , j , k}^{zmin}$$

for any grid node (i, j, k) not yet reached by the wave front. Thus, Eqn. (18) can be simplified as:

$${( \frac{{T}_{i , j , k}^{new} - {T}_{i , j , k}^{xmin}}{h} )}^{2} + {( \frac{{T}_{i , j , k}^{new} - {T}_{i , j , k}^{ymin}}{h} )}^{2} + {( \frac{{T}_{i , j , k}^{new} - {T}_{i , j , k}^{zmin}}{h} )}^{2} = {S}_{i , j , k}^{2} \qquad Eqn ( 22 )$$

Eqn (20) is a quadratic equation in terms of the unknown

$${T}_{i , j , k}^{new}$$

However, before accepting a solution to Eqn (2) as valid, its causality must be checked. For example, in 2D, the Eikonal equation for high order accuracy is solved as:

$${T}_{i , j}^{new} = \{ \begin{matrix}min ( {T}_{i , j}^{xmin} , {T}_{i , j}^{ymin} ) + h \cdot {S}_{i , j} , & \vert {T}_{i , j}^{xmin} - {T}_{i , j}^{ymin} \vert \geq h \cdot {S}_{i , j} , \\ \frac{{T}_{i , j}^{xmin} + {T}_{i , j}^{ymin} + \sqrt{2 {h}^{2} \cdot {S}_{i , j}^{2} - {( {T}_{i , j}^{xmin} - {T}_{i , j}^{ymin} )}^{2}}}{2} , & otherwise\end{matrix} \qquad Eqn ( 23 )$$

The second row of Eqn (23) may be called the “two-sided update”, as both parents

$${T}_{i , j}^{xmin} and {T}_{i , j}^{ymin}$$

are taken into account. The two-sided update is only accepted if

$$\vert {T}_{i , j}^{xmin} - {T}_{i , j}^{ymin} \vert < h \cdot {S}_{i , j} .$$

When this condition fails, the one-sided update, i.e., the first row of Eqn (21) is used.

In 3D, denoting

$${T}_{i , j , k}^{xmin} , {T}_{i , j , k}^{ymin} , {T}_{i , j , k}^{zmin}$$

as a₁, a₂, a₃, respectively, where a₁≤a₂≤a₃. Then the Eikonal equation. Eqn (22), may be solved as:

$${T}_{i , j , k}^{new} = \{ \begin{matrix}\frac{2 ( {a}_{1} + {a}_{2} + {a}_{3} ) + \sqrt{4 {( {a}_{1} + {a}_{2} + {a}_{3} )}^{2} - 12 ( {a}_{1}^{2} + {a}_{2}^{2} + {a}_{3}^{2} - {h}^{2} \cdot {S}_{i , j , k}^{2} )}}{6} , & \vert {a}_{1} - {a}_{3} \vert < h \cdot {S}_{i , j , k} , \\ \frac{{a}_{1} + {a}_{2} + \sqrt{2 {h}^{2} \cdot {S}_{i , j , k}^{2} - {( {a}_{1} - {a}_{2} )}^{2}}}{2} , & \vert {a}_{1} - {a}_{2} \vert < h \cdot {S}_{i , j , k} , \\ {a}_{1} + h \cdot {S}_{i , j , k} , & otherwise .\end{matrix} \qquad Eqn ( 24 )$$

The expressions of Eq. (22) may function as a local solver to update the traveltime at a node from traveltimes for its spatial neighbors.

The process summarized in Eqn (24) is particularly well suited for implementation on highly-parallel computer systems, such as graphical processing unit (“GPUs”). For the simplicity of explanation, the implementation of the high order scheme is disclosed for two-dimensional embodiment first, although will be clear to one of ordinary skill in the art how to modify this implementation for a 3D embodiment.

In accordance with one of more embodiments, a global solution, i.e., for the whole grid of nodes, of seismic traveltime may be determined using the parallel fast sweeping Cuthill-McKee ordering method. This iterative process terminates only when the convergence is reached.

Letting the superscript index “n” of T⁽ⁿ⁾ represents the iteration index. The first iteration begins with an initial value of T⁽⁰⁾(Γ)=0 at the seismic source location. T⁽⁰⁾ at other nodes on the grid may then be set to the value of the solution from the first order fast sweeping method. For current grid node (i, j), the level of grid node is defined as level=i+j. At each iteration, the high order solution

$${T}_{i , j}^{new}$$

at grid nodes within a single level are computed simultaneously by the local solver (21) on GPU devices, and new T⁽ⁿ⁾ at each grid node is from the high order solution

$${T}_{i , j}^{new}$$

The iterative procedure for 2D case on GPI, can be summarized as below:

```
(a) n = 1, initialize T⁽⁰⁾;
$( b ) {\tilde{T}}_{i , j} = {T}^{( n - 1 )} ;$
(c) for ordering = 1:2², [do axes rotation]
for level = 2:I + J, do
  I_{L} = max(1, level − J), I₂ = min(I, level − 1)
  parallel for i = I₁:I₂,
  $do j = level - i , [ \text{} computation of {T}_{i , j}^{new} using Eqn ( 24 ) on GPU with Eqn ( 9 ) ]$
    ${\tilde{T}}_{i , j} = {T}_{i , j}^{new} ;$
(d) T⁽ⁿ⁾ = \tilde{T}_{i,j};
(e)  if T⁽ⁿ⁾ = T⁽ⁿ⁻¹⁾, [stop loop; otherwise n = n + 1 and go to step (b)]
```

The 3D version of this process proceeds in an analogous fashion using the local solver, Eqn (24). Noted that in 3D embodiments, for the grid iode (i, j, k), the level is defined as level=i+j+k, and the ordering=1:2³, rather than ordering=1:2², as above for the 2D embodiment.

In both 2D and 3D the determination and use of the propagation direction dependent anisotropic slowness. S_{i,j,k}, significantly increases the cost of determining the traveltimes compared to the case of a direction invariant isotropic slowness. In accordance with some embodiments, the convergence of fast sweeping process in an anisotropic medium may be accelerated by first determining an isotropic medium that approximates the anisotropic medium. The traveltime in the approximate isotropic medium may then be determined and used as an approximate value for the traveltime in the anisotropic medium and initialize T⁽⁰⁾ in step (a) above. Thereafter, the iterative procedure, steps (a)-(e) above, may be performed using the propagation direction dependent anisotropic slowness to obtain an accurate anisotropic traveltime.

In some embodiments, when an initial isotropic approximation is used the isotropic traveltimes may be calculated with the same iterative procedure, steps (a)-(e) above, but an isotropic slowness in place of the anisotropic slowness. However, other embodiments may utilize any of a number of alternative methods of determining isotropic traveltime known to those of ordinary skill in the art, without departing from the scope of the invention.

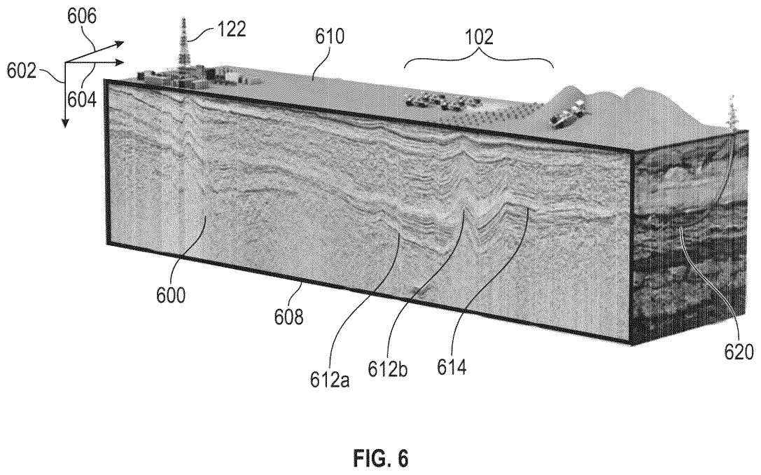

Once determined in the manner described above, the anisotropic traveltimes may be integrated into other steps of seismic processing chain. In particular, traveltimes may be used to combine record seismic data, such as seismic data (250) to form a seismic image. FIG. 6 shows an example of a seismic image (600) in accordance with one or more embodiments. Seismic image (600) is displayed as a 3D volume display against a depth axis (602) and two mutually orthogonal horizontal axes (604) and (606), however seismic image is often interpreted to mean only a 2D slice, vertical, horizontal, on a deformed surface. For example, slice (608) may be termed a seismic image.

The seismic image (600) may be formed with data acquired on the surface (610) above the subterranean region with a seismic acquisition system (102). In some embodiments, the data may be replaced or supplemented with data acquired with borehole seismic acquisition systems (not shown) that may have either one or more sources and/or one or more receivers located in a wellbore penetrating the subsurface.

FIG. 6 also illustrates the processes into which the seismic image may be integrated. The seismic image (600) may show the boundaries of subsurface strata, such as geological interfaces (612a, 612b) or geological faults (614). Geological interfaces and geological faults such as these may form the boundaries of hydrocarbon reservoirs. A hydrocarbon reservoir may be identified and located from a seismic image, such as seismic image (600), using a seismic interpretation workstation (110). In some embodiments other remote sensing data, such as gravity, magnetic, or electromagnetic data, may be used to supplement and/or replace portions of the seismic data to facilitate identification and location of the hydrocarbon reservoir. One or more wellbores may be planned, using a wellbore planning system (118) to penetrate the interpreted hydrocarbon reservoir location and a wellbore may be drilled using a drilling system (122) guided by each of the one or more planned wellbores. The resulting wellbores, such as wellbore (620) may be used to produce hydrocarbons, such as oil and gas, from the penetrated hydrocarbon reservoir.

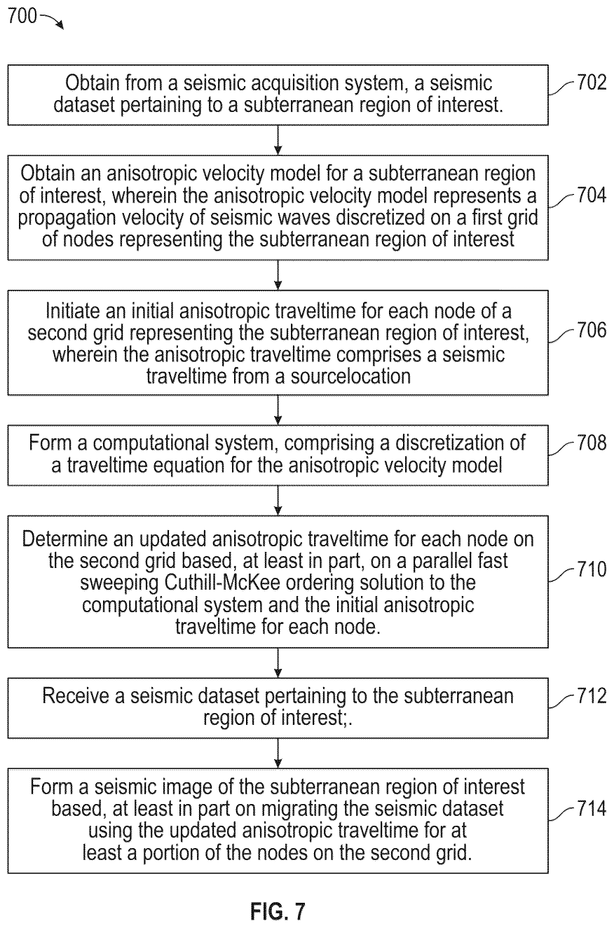

FIG. 7 shows a flowchart (700) in accordance with one or more embodiments. Flowchart (700) describes steps of one or more embodiments for determining a seismic image using traveltimes determined for an anisotropic velocity model of a subterranean region.

In Step (702) a seismic dataset pertaining to a subterranean region of interest may be obtained using a seismic acquisition system. In some embodiments the seismic acquisition system may be a terrestrial seismic acquisition system with seismic receivers configured to record the velocity of ground motion caused by seismic waves excited by a seismic source. In other embodiments the seismic acquisition system may be a marine seismic acquisition system configured to record pressure fluctuations in the water (ocean), and/or the velocity of seabed motion, caused by seismic waves excited by a seismic source.

In Step (704) an anisotropic velocity model for a subterranean region of interest may be obtained. The anisotropic velocity model may represent a propagation velocity of seismic waves discretized on a first grid of nodes representing the subterranean region of interest. In some embodiments, the anisotropic velocity model may be a transversely isotropic velocity model, including a transversely isotropic velocity model with a vertical axis of symmetry. Further the anisotropic velocity model may be a weak anisotropic velocity model that may be parameterized by Thomson parameters.

In Step (706) an initial anisotropic traveltime for each node of a second grid representing the subterranean region of interest may be initiated. The anisotropic traveltime at each node on the second grid may be a seismic traveltime from a source location within or upon the subterranean region of interest. Initiating the initial anisotropic traveltime may include determining an isotropic approximation to the traveltime. Determining the isotropic approximation to the traveltime may include determining an isotropic velocity model approximating the anisotropic velocity model, initiating an isotropic traveltime for each node of the second grid, forming a computational system comprising the higher-order WENO approximation to the Godunov upwind-difference scheme discretization of the Eikonal equation for the isotropic velocity model, and determining an updated isotropic traveltime for each node on the second grid based, at least in part, on the parallel fast sweeping Cuthill-McKee ordering solution to the computational system and the initial isotropic traveltime for each node. The first grid may be equivalent or identical to the second grid or may be a coarser or a finer grid, or may be specified using a different coordinate system. For example, the first grid may be a Cartesian grid while the second grid may be a cylindrical grid. In some iterations the higher-order WENO may be a third-order WENO, whereas in other iterations the higher-order WENO may be a fifth-order WENO.

In Step (708) a computational system may be formed using a discretization of a traveltime equation for the anisotropic velocity model. In some embodiments the discretization of the traveltime equation may include a higher-order Weighted Essentially Non-Oscillatory (WENO) approximation. In some embodiments the discretization of the traveltime equation may include a Godunov upwind-difference scheme. In some embodiments the discretization of the traveltime equation may include a discretization of an Eikonal equation.

In Step (710) an updated anisotropic traveltime for each node on the second grid may be determined based, at least in pan, on a parallel fast sweeping Cuthill-McKee ordering solution to the computational system and the initial anisotropic traveltime for each node. The parallel fast sweeping Cuthill-McKee ordering solution may include an iterative loop that terminates when a stopping criterion is met. The stopping criterion may include summing over each node of the second grid an estimated traveltime from a current iteration.

In Step (712) a seismic image of the subterranean region of interest may be formed based, at least in part on migrating the seismic dataset using the updated anisotropic traveltime for at least a portion of the nodes on the second grid. In some embodiments, the migration may be performed using a Kirchhoff prestack-depth migration method, while in other embodiments the migration may be performed using a Kirchhoff poststack-depth migration method. In still other embodiments, the migration may be performed using a beam-migration method such as a Gaussian beam migration method.

The resulting seismic image may be used to identify a drilling target. A seismic interpretation workstation may be used to facilitate the interpretation of the seismic image and geological structures, including hydrocarbon reservoirs manifested therein. The drilling target may be a localized position in the hydrocar bon reservoir or may be an extended are running through the hydrocarbon reservoir or a portion thereof. In the absence of a seismic image of the subsurface the exploration for commercially exploitable hydrocarbons would essentially be performed “blind” with wellbore locations and depths chosen a random or using crude heuristics and resulting in may wellbores that fail to penetrate a hydrocarbon reservoir and that produce only brine or fresh water. Consequently, determining an accurate seismic image by utilizing high fidelity seismic traveltimes even when the subsurface exhibits anisotropic seismic velocities, forms a extremely valuable step in the process of finding and producing hydrocarbons from the subsurface.

A wellbore trajectory may subsequently be planned guided, at least in part, by the drilling target. Other factors influencing the wellbore trajectory may include available surface locations from which to begin drilling and at which to position the wellhead. For example, existing wellsite on land, and particularly drilling rigs offshore may be strongly preferred over a new well site. The planned wellbore trajectory may be contained m the wellbore drilling plan (120) and the wellbore drilling plan may also specify the “weight” or density of drilling mud, and the casing weight and circumference to use and planned drilled depths at which drilling may pause, casing be inserted, worn or “dull” drill bits replaced, and wellbore caliper reduced.

The planned wellbore trajectory contained in the wellbore drilling plan (120) may then be transferred to a drilling system (122)) such that the wellbore path (804) may be drilled as illustrated in FIG. 8 in accordance with one or more embodiments. Although the drilling system (122) is displayed as located on land, the drilling system (122) may also be a marine wellbore drilling system positioned on a jack-up rig, a floating rig, or a drill ship. As such, the illustrated drilling system (122) is not intended to limit the present disclosure.

FIG. 8 illustrates a drilling system (122) in accordance with one or more embodiments. A wellbore (805) nay be drilled, using the drilling system (122), guided by the planned wellbore path (810) to penetrate the hydrocarbon reservoir (204). Although the drilling system (122) shown in FIG. 8 is used to drill the wellbore (805) on land, the drilling system (122) may also be a marine wellbore drilling system. The example of the drilling system (122) shown m FIG. 8 is not meant to limit the present disclosure.

As shown in FIG. 8, the wellbore (805) may be drilled using a drill rig that may be situated on a land drill site, an offshore platform, such as a jack-up rig, a semi-submersible, or a drill ship. The drill rig may be equipped with a hoisting system, such as a derrick (815), which can raise or lower the drillstring (820) and other tools required to drill the wellbore (805). The drillstring (820) may include one or more drill pipes connected to form conduit and a bottom hole assembly (825) (BHA) disposed at the distal end of the drillstring (820). The BHA (825) may include a drill bit (830) to cut into rock (860), including cap rock (860a). The BHA (825) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit (830), the weight-on-bit, and the torque. The LWD measurements may include sensors, such as resistivity, gamma ray, and neutron density sensors, to characterize the rock (860) surrounding the wellbore (805). Both MWD and LWD measurements may be transmitted to the surface of the earth (216) using any suitable telemetry system known in the art, such as a mud-pulse or by wired-drillpipe.

To start drilling, or “spudding in,” the wellbore (805), the hoisting system lowers the drillstring (820) suspended from the derrick (815) towards the planned surface location of the wellbore (805). An engine, such as a diesel engine, may be used to supply power to the top drive (835) to rotate the drillstring (820) via the drive shaft (840). The weight of the drillstring (820) combined with the rotational motion enables the drill bit (830) to bore the wellbore (805).

The near-surface of the subterranean region of interest 202 is typically made up of loose or soft sediment or rock (860), so large diameter casing (845) (e.g., “base pipe” or “conductor casing”) is often put in place while drilling to stabilize and isolate the wellbore (805). At the top of the base pipe is the wellhead, which serves to provide pressure control through a series of spools, valves, or adapters (not shown). Once near-surface drilling has begun, water or drill fluid may be used to force the base pipe into place using a pumping system until the wellhead is situated just above the surface of the earth (216).

Drilling may continue without any casing (845) once deeper or more compact rock (860) is reached. While drilling, a drilling mud system (850 may pump drilling mud from a mud tank on the surface of the earth (216) through the drill pipe. Drilling mud serves various purposes, including pressure equalization, removal of rock cuttings, and drill bit cooling and lubrication.

At planned depth intervals, drilling may be paused and the drillstring (820) withdrawn from the wellbore (805). Sections of casing (845) may be connected and inserted and cemented into the wellbore (805). Casing string may be cemented in place by pumping cement and mud, separated by a “cementing plug,” from the surface of the earth (216) through the drill pipe. The cementing plug and drilling mud force the cement through the drill pipe and into the annular space between the casing (845) and the wall of the wellbore (805). Once the cement cures, drilling may recommence. The drilling process is often performed in several stages. Therefore, the drilling and casing cycle may be repeated more than once, depending on the depth of the wellbore (805) and the pressure on the walls of the wellbore (805) from surrounding rock (860).

Due to the high pressures experienced by deep wellbores (805), a blowout preventer (BOP) may be installed at the wellhead to protect the rig and environment from unplanned oil or gas releases. As the wellbore (805) becomes deeper, both successively smaller drill bits (830) and casing (845) may be used. Drilling deviated or horizontal wellbores (805 may require specialized drill bits (830) or drill assemblies.

The drilling system (122) may be disposed at and communicate with other systems in the wellbore environment. The drilling system (122) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target with the hydrocarbon reservoir (204) is reached or the presence of hydrocarbons is established.

In some embodiments the wellbore planning system (118), the seismic processing system (106), and the seismic interpretation workstation (110) may each include a computer system.

Embodiments may be implemented on a computer system. FIG. 9 is a block diagram of a computer system (900) used to provide computational functionalities associated with described algorithms, methods, functions, processes, flows, and procedures as described in the instant disclosure, according to an implementation. The illustrated computer system (900) is intended to encompass any computing device such as a high performance computing (HPC) device, a server, desktop computer, laptop, notebook computer, wineless data port, smart phone, personal data assistant (PDA), tablet computing device, one or more processors within these devices, or any other suitable processing device, including both physical or virtual instances (or both) of the computing device. Additionally, the computer system (900) may include a computer that includes an input device, such as a keypad, keyboard, touch screen, or other device that can accept user information, and an output device that conveys information associated with the operation of the computer system (900), including digital data, visual, or audio information f or a combination of information), of a GUI.

The computer system (900) can serve in a role as a client, network component, a server, a database or other persistency, or any other component (or a combination of role-s) of a computer system for performing the subject matter described in the instant disclosure. The illustrated computer system (900) is communicably coupled with a network (902). In sone implementations, one or mote components of the computer system (900) may be configured to operate within environments, including cloud-computing-based, local, global, or other environment (or a combination of environments).

At a high level, the computer system (900) is an electronic computing device operable to receive, transmit, process, store, or manage data and information associated with the described subject matter. According to some implementations, the computer system (900) may also include or be communicably coupled with an application server, e-mail server, web server, caching server, streaming data server, business intelligence (131) server, or other server (or a combination of servers).

The computer system (900) can receive requests over network (902) from a client application (for example, executing on another computer system (900)) and responding to the received requests by processing the said requests in an appropriate software application. In addition, requests may also be sent to the computer system (900) from internal users (for example, from a command console or by other appropriate access method), external or third-parties, other automated applications, as well as any other appropriate entities, individuals, systems, or computers.

Each of the components of the computer system (900) can communicate using a system bus (904). In some implementations, any or all of the components of the computer system (900), both hardware or software (or a combination of hardware and software), may interface with each other or the interface (906) or a combination of both) over the system bus (904) using an application programming interface (API) (908) or a service layer (910) (or a combination of the API (908) and service layer (910). The API (908) may include specifications for routines, data structures, and object classes. The API (908) may be either computer-language independent or dependent and refer to a complete interface, a single function, or even a set of APIs. The service layer (910) provides software services to the computer system (900) or other components (whether or not illustrated) that are communicably coupled to the computer (900). The functionality of the computer (900) may be accessible for all service consumers using this service layer. Software services, such as those provided by the service layer (910), provide reusable, defined business functionalities through a defined interface. For example, the interface may be software written in JAVA, C++, or other suitable language providing data in extensible markup language (XML) format or other suitable format. While illustrated as an integrated component of the computer (900), alternative implementations may illustrate the API (908) or the service layer (910) as stand-alone components in relation to other components of the computer (900) or other components (whether or not illustrated) that are communicably coupled to the computer (900). Moreover, any or all parts of the API (908) or the service layer (910) may be implemented as child or sub-modules of another software module, enterprise application, or hardware module without departing from the scope of this disclosure.

The computer (900) includes an interface (906). Although illustrated as a single interface (906) in FIG. 9, two or more interfaces (906) may be used according to particular needs, desires, or particular implementations of the computer (900). The interface (906) is used by the computer (900) for communicating with other systems in a distributed environment that are connected to the network (902). Generally, the interface (906) includes logic encoded in software or hardware (or a combination of software and hardware) and operable to communicate with the network (902). More specifically the interface (906) may include software supporting one or more communication protocols associated with communications such that the network (902) or interface's hardware is operable to communicate physical signals within and outside of the illustrated computer (900).

The computer (900) includes at least one computer processor (912). Although illustrated as a single computer processor (912) in FIG. 9, two or more processors may be used according to particular needs, desires, or particular implementations of the computer (900). Generally, the computer processor (912) executes instructions and manipulates data to perform the operations of the computer (900) and any algorithms, methods, functions, processes, flows, and procedures as described in the instant disclosure.

The computer (900) also includes a memory (914) that holds data for the computer (900) or other components (or a combination of both) that may be connected to the network (902). For example, memory (914) may be a database storing, data consistent with this disclosure. Although illustrated as a single memory (914) in FIG. 9, two or more memories may be used according to particular needs, desires, or particular implementations of the computer (900) and the described functionality. While memory (914) is illustrated as an integral component of the computer (900), in alternative implementations, memory (914) may be external to the computer (900).

In addition to holding data, the memory may be a non-transitory medium storing computer readable instruction capable of execution by the computer processor (912) and having the functionality for carrying out manipulation of the data including mathematical computations.

The application (916) is an algorithmic software engine providing functionality according to particular needs, desires, or particular implementations of the computer (900), particularly with respect to functionality described in this disclosure. For example, application (916) can serve as one or more components, modules, applications, etc. Further, although illustrated as a single application (916), the application (916) may be implemented as multiple applications (916) on the computer (900). In addition, although illustrated as integral to the computer (900), in alternative implementations, the application (916) may be external to the computer (900).

There may be any number of computers (900) associated with, or external to, a computer system containing computer (900), each computer (900) communicating over network (902). Further, the term “client,” “user,” and other appropriate terminology may be used interchangeably as appropriate without departing from the scope of this disclosure. Moreover, this disclosure contemplates that many users may use one computer (900), or that one user may use multiple computers (900).

In some embodiments, the computer (900) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining an anisotropic velocity model for a subterranean region of interest,
wherein the anisotropic velocity model represents a propagation velocity of seismic waves discretized on a first grid of nodes representing the subterranean region of interest;
initiating an initial anisotropic traveltime for each node of a second grid representing the subterranean region of interest,
wherein the anisotropic traveltime comprises a seismic traveltime from a source location;
forming a computational system, comprising a discretization of a traveltime equation for the anisotropic velocity model; and
determining an updated anisotropic traveltime for each node on the second grid based, at least in part, on a parallel fast sweeping Cuthill-McKee ordering solution to the computational system and the initial anisotropic traveltime for each node.

2. The method of claim 1, wherein the discretization of the traveltime equation comprises a higher-order Weighted Essentially Nou-Oscillatory (WENO) approximation to a Godunov upwind-difference scheme discretization of an Eikonal equation.

3. The method of claim 1, wherein initiating the initial anisotropic traveltime comprises determining an isotropic approximation to the traveltime.

4. The method of claim 3, wherein initiating the initial anisotropic traveltime further comprises:
determining an isotropic velocity model approximating the anisotropic velocity model; initiating an isotropic traveltime for each node of the second grid;
forming a computational system comprising the higher-order WENO approximation to the Godunov upwind-difference scheme discretization of the Eikonal equation for the isotropic velocity model; and
determining an updated isotropic traveltime for each node on the second grid based, at least in part, on the parallel fast sweeping Cuthill-McKee ordering solution to the computational system and the initial isotropic traveltime for each node.

5. The method of claim 1, further comprising:
receiving a seismic dataset pertaining to the subterranean region of interest; and
forming a seismic image of the subterranean region of interest based, at least in part, on migrating the seismic dataset using the updated anisotropic traveltime for at least a portion of the nodes on the second grid.

6. The method of claim 5, further comprising:
identifying, using a seismic interpretation workstation, a drilling target based, at least in part, on the seismic image;
planning, using a well planning system, a wellbore trajectory guided by the drilling target; and
drilling, using a drilling system, a wellbore guided by the wellbore trajectory.

7. The method of claim 1, wherein the anisotropic velocity model comprises a transversely isotropic model.

8. The method of claim 1, wherein the parallel fast sweeping Cuthill-McKee ordering solution comprises an iterative loop that terminates when a stopping criterion is met.

9. The method of claim 8, wherein the stopping criterion comprises summing over each node of the second grid an estimated traveltime from a current iteration.

10. The method of claim 1, wherein the anisotropic velocity model comprises a weak anisotropic velocity model parameterized by Thomson parameters.

11. The method of claim 1, wherein the first grid comprises the second grid.

12. The method of claim 2, wherein the higher-order WENO comprises a third-order WENO.

13. A non-transitory computer-readable storage medium storing instructions executable by a computer processor, that when executed by the computer processor perform steps comprising:
receiving an anisotropic velocity model for a subterranean region of interest,
wherein the anisotropic velocity model represents a propagation velocity of seismic waves discretized on a first grid of nodes representing the subterranean region of interest;
initiating an initial anisotropic traveltime for each node of a second grid representing the subterranean region of interest,
wherein the anisotropic traveltime comprises a seismic traveltime from a source location;
forming a computational system, comprising a discretization of a traveltime equation for the anisotropic velocity model;
determining an updated anisotropic traveltime for each node on the second grid based, at least in part, on a parallel fast sweeping Cuthill-McKee ordering solution to the computational system and the initial anisotropic traveltime for each node
receiving a seismic dataset pertaining to the subterranean region of interest; and
forming a seismic image of the subterranean region of interest based, at least in part on migrating the seismic dataset using the updated anisotropic traveltime for at least a portion of the nodes on the second grid.

14. The non-transitory computer-readable storage medium of claim 13, wherein the discretization of the traveltime equation comprises a higher-order Weighted Essentially Non-Oscillatory (WENO) approximation to a Godunov upwind-difference scheme discretization of an Eikonal equation.

15. The non-transitory computer-readable storage medium of claim 13, wherein initiating the initial anisotropic traveltime comprises determining an isotropic approximation to the traveltime.

16. A system, comprising:
a seismic processing system, configured to:
receive an anisotropic velocity model for a subterranean region of interest,
wherein the anisotropic velocity model represents a propagation velocity of seismic waves discretized on a first grid of nodes representing the subterranean region of interest,
initiate an initial anisotropic traveltime for each node of a second grid representing the subterranean region of interest,
wherein the anisotropic traveltime comprises a seismic traveltime from a source location,
form a computational system comprising a higher-order weighted essentially non-oscillatory (WENO) approximation to a Godunov upwind-difference scheme discretization of an Eikonal equation for the anisotropic velocity model,
determine an updated anisotropic traveltime for each node on the second grid based, at least in part, on a parallel fast sweeping Cuthill-McKee ordering solution to the computational system and the initial anisotropic traveltime for each node,
receive a seismic dataset pertaining to the subterranean region of interest, and
form a seismic image of the subterranean region of interest based, at least in part on migrating the seismic dataset using the updated anisotropic traveltime for at least a portion of the nodes on the second grid; and
a seismic interpretation workstation configured to identify a drilling target based, at least in part, on the seismic image.

17. The system of claim 16, wherein the initial anisotropic traveltime comprises an isotropic approximation to the traveltime.

18. The system of claim 16, further comprising:
a well planning system configured to plan a wellbore trajectory guided by the drilling target; and
a drilling system configured to drill a wellbore guided by the wellbore trajectory.

19. The system of claim 16, wherein the anisotropic velocity model comprises a transversely isotropic model.

20. The system of claim 16, wherein the higher-order WENO comprises a third-order WENO.
